(19) United States
(12) Patent Application Publication
(10) Pub. No.: US 2003/0136930 A1
(43) Pub. Date: Jul. 24, 2003

(54) Non-coaxial rotary linkage

(76) Inventors: David E. Dowden, Ontario, NY (US); Donald G. Witzel, Pittsford, NY (US)

Correspondence Address: Delphi Technologies, Inc., P.O. Box 5052, Mail Code 480414420, Troy, MI, 48007, US

(21) Appl. No.: 10/055,557

(22) Filed: Jan. 23, 2002

(51) Int. Cl. F16H 35/18; F16K 31/02

(52) U.S. Cl. 251/129.11; 251/279; 74/10.9

(57) ABSTRACT

An amplifying linkage for rotational actuation between a driving shaft and a driven shaft wherein the driving shaft rotates through a first rotary angle and the driven shaft rotates through a second and different rotary angle. The driven shaft is provided with a first lever arm having a slot formed in its distal end, and the driving shaft is provided with a second lever arm having a pin protruding in a direction parallel to the axis of the driven shaft. The shafts are offset such that the pin is receivable and slidable in the slot. Rotation of the driving shaft through a first angle causes the driven shaft to be rotated through a second angle. The first lever arm is shorter than the second lever arm, so that the second angle is always greater than the first (angular rotation is amplified). The invention is particularly useful in adapting a four-pole torque motor to the actuation of an Electric Throttle Control throttle valve for an internal combustion engine.

### TECHNICAL FIELD

The present invention relates to shaft-to-shaft linkages; more particularly, to such linkages between a rotary driving shaft and a driven shaft; and most particularly, to such a linkage wherein the shafts are axially offset and wherein the driving shaft rotates through a first rotary angle and the driven shaft rotates through a second and different rotary angle.

### BACKGROUND OF THE INVENTION

In many well known applications, a shaft is required to be rotated through a predetermined rotary angle. For example, a throttle valve shaft may be required to rotate controllably from a first position, wherein an attached throttle butterfly valve is substantially closed, through an actuation angle of about 80° to a second position, wherein the butterfly valve is substantially wide open.

Historically, in the automotive art, such actuation has been carried out mechanically via a lever arm attached to the throttle valve shaft and also attached via various linkages to a foot pedal of a vehicle. More recently, and especially with the advent of electronic engine controls, it is desirable in some applications to actuate the throttle valve shaft electromechanically. One means of achieving electromechanical actuation is to coaxially couple the output shaft of an electric motor to the shaft to be rotated. Many types of electric motors are unsuited to this task, which requires an actuation range of only a small fraction of one revolution. A known approach is to use a brush DC motor with a two-stage spur gear drive. This drive is good for multiplying the torque output of the motor but possesses significant back drive friction and decreased powered speed of the shaft. It also requires the shafts of the motor and the application to be offset by a substantial amount to maintain robustness in gear teeth.

The evolution of DC torque motors permits a shaft to be driven directly by a motor. DC torque motors are known to be useful in applications requiring only a partial revolution. For example, a commercially-available Electronic Throttle Control (ETC) throttle body incorporates a two-pole DC torque motor. An advantage of a two-pole torque motor in actuating a throttle valve is that the motor has a useful rotation angle of approximately 120°, and the valve requires less than 90° of actuation. A limitation of such a motor is that the inherent torque is low, typically about 0.7 Nm, well below the level of about 2.0 Nm generally considered useful in precisely actuating large throttle butterfly valves. It is known that a four-pole torque motor can provide the desired torque output, but the tradeoff is that a four-pole motor has an effective range of rotation of about 55°, well below the required actuation range of a throttle valve.

Therefore, there is a strong need for an improved Electronic Throttle Control actuator wherein the limited rotational range of a four-pole DC motor is rotationally amplified to actuate an associated throttle valve over a rotational range approaching 90°.

It is a principal object of this invention to provide an improved mechanism for driving a shaft through a predetermined rotary angle wherein the driving shaft rotates through a first rotary angle and the driven shaft rotates through a second and different rotary angle, the shafts being axially offset.

It is a further object of this invention to provide an improved Electronic Throttle Control means wherein a four-pole DC torque motor actuates a throttle valve through an arc of about 90° under a torque level of at least 2.0 Nm.

### SUMMARY OF THE INVENTION

Briefly described, the present invention is directed to an improved linkage for rotational actuation between a driving shaft and a driven shaft wherein the driving shaft rotates through a first rotary angle and the driven shaft rotates through a second and different rotary angle. The driven shaft is provided with a first lever arm having a slot formed in its distal end. The drive shaft is provided with a second lever arm having a pin protruding in a direction parallel to the axis of the driven shaft. The driving and driven shafts are offset such that the pin is receivable in the slot at all angles of rotation of the driving shaft and driven shaft. Rotation of the driving shaft through a first angle causes the driven shaft to be rotated through a second angle. When the driven axis is disposed between the driving axis and the pin axis, that is, when the driven lever arm is shorter than the driving lever arm, the second angle is always greater than the first (angular rotation is amplified). When the driving axis is disposed between the driven axis and the pin axis, that is, when the driving lever arm is shorter than the driven lever arm, the second angle is always less than the first (angular rotation is reduced). The invention is particularly useful in adapting a four-pole torque motor to the actuation of a throttle valve.

### BRIEF DESCRIPTION OF THE DRAWINGS

The foregoing and other objects, features, and advantages of the invention, as well as presently preferred embodiments thereof, will become more apparent from a reading of the following description in connection with the accompanying drawings in which:

FIG. 1 is a schematic view of an angular rotation amplifier in accordance with the invention;

FIG. 2 is a plan view of a throttle body having a throttle valve coupled to an actuating torque motor via a non-coaxial rotary linkage comprising an angular rotation amplifier similar to that shown in FIG. 1;

FIG. 3 is an end view of the throttle body shown in FIG. 2, taken from section 3-3 in FIG. 2, showing the linkage in the valve-closed position;

FIG. 4 is a cutaway plan view of the linkage, motor, and throttle body shown in FIGS. 2 and 3;

FIG. 5 is a view like that shown in FIG. 3, showing the linkage in the valve-open position;

FIG. 6 is a cutaway plan view of the linkage, motor, and throttle body shown in FIGS. 2 and 5; and

FIG. 7 is a schematic view of an angular rotation reducer in accordance with the invention.

### DESCRIPTION OF THE PREFERRED EMBODIMENTS

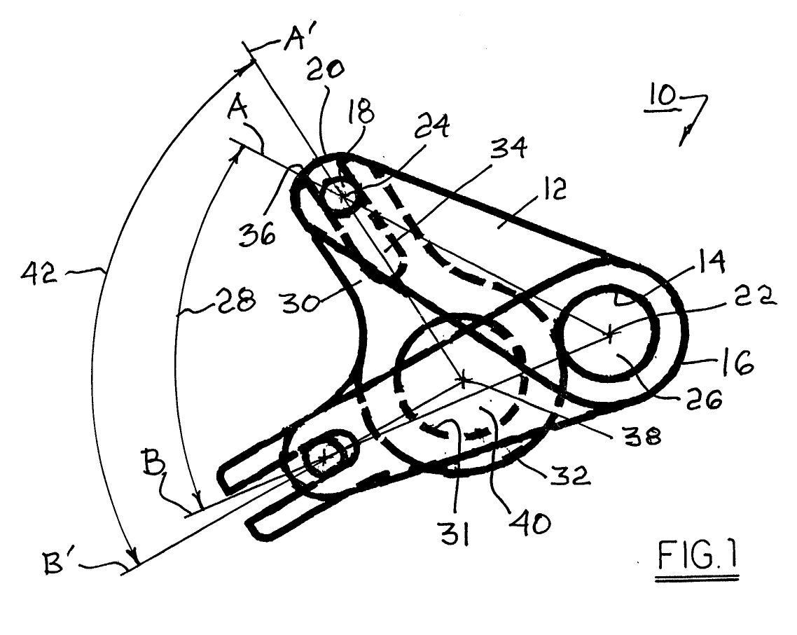

Referring to FIG. 1, rotation amplifier 10 includes a driving arm 12 having a bore 14 formed near a proximal end 16 thereof and a pin 18 rigidly disposed near a distal end 20 thereof. Bore 14 has an axis 22 generally orthogonal to a plane containing arm 12, and pin 18 has an axis 24 generally parallel to axis 22. Driving arm 12 is adapted for rigid mounting via bore 14 in known fashion on a rotatable driving shaft 26 for actuation of arm 12 from a first angular orientation A through angle 28 to a second angular orientation B, which may be about 56° as shown in FIG. 1. The axis of shaft 26 is coincident with axis 22 of bore 14.

Rotation amplifier 10 further includes a driven arm 30 having a bore 31 formed near a proximal end 32 thereof and a slot 34, preferably radial from bore 31, formed in a distal end 36 thereof. Bore 31 has an axis 38 generally orthogonal to a plane containing arm 30. Driven arm 30 is adapted for rigid mounting via bore 31 in known fashion on a rotatable driven shaft 40 for actuation by arm 30 from a first angular orientation A′ through angle 42 to a second angular orientation B′, which may be about 90° as shown in FIG. 1. The axis of shaft 40 is coincident with axis 38 of bore 31 and is substantially parallel to, and non-coaxial with, axes 22 and 24.

In operation, rotation of driving shaft 26 and driving arm 12 from a first angular orientation A through an angle 28 to a second angular orientation B causes driven arm 30 and driven shaft 40 to be rotated from a first angular orientation A′ through an angle 42 to a second angular orientation B′. Because axis 38 lies between axis 22 and axis 24 (that is, the distance between axes 22 and 24 is always greater than the distance between axes 38 and 24), angle 42 is greater than angle 28, and the rotary motion of driven shaft 40 is amplified from the rotary motion of driving shaft 26.

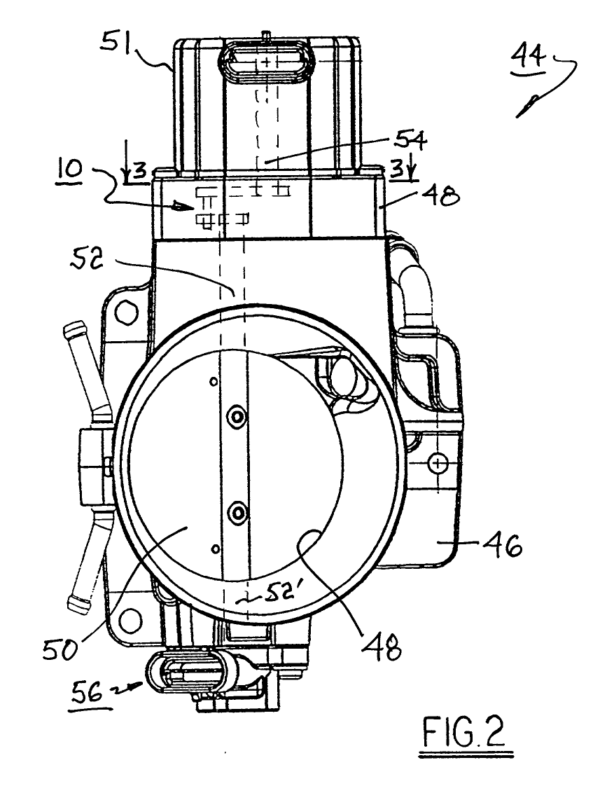

Referring to FIG. 2, an Electronic Throttle Control throttle valve assembly 44 includes a throttle body 46 having a throat 48 therethrough and a butterfly 50 mounted on a rotatable throttle shaft 52 disposed in bores in throttle body 46. A rotational amplifier 10 is disposed in a transmission housing 48 connecting an electric motor 51, preferably a four-pole torque motor, to the throttle shaft 52. The output shaft 54 of motor 51 is analogous to driving shaft 26, and throttle shaft 52 is analogous to driven shaft 40 in FIG. 1.

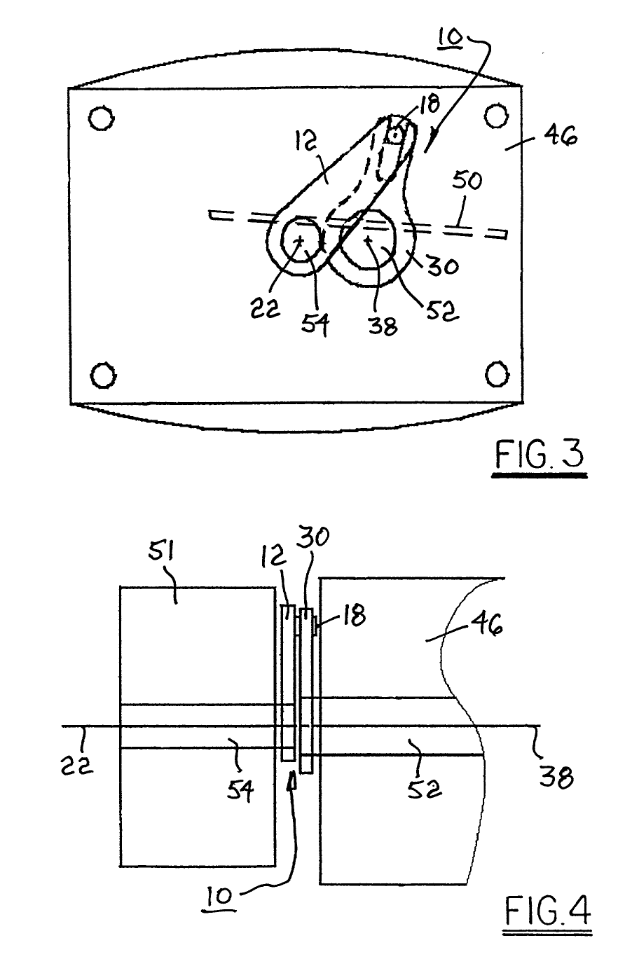

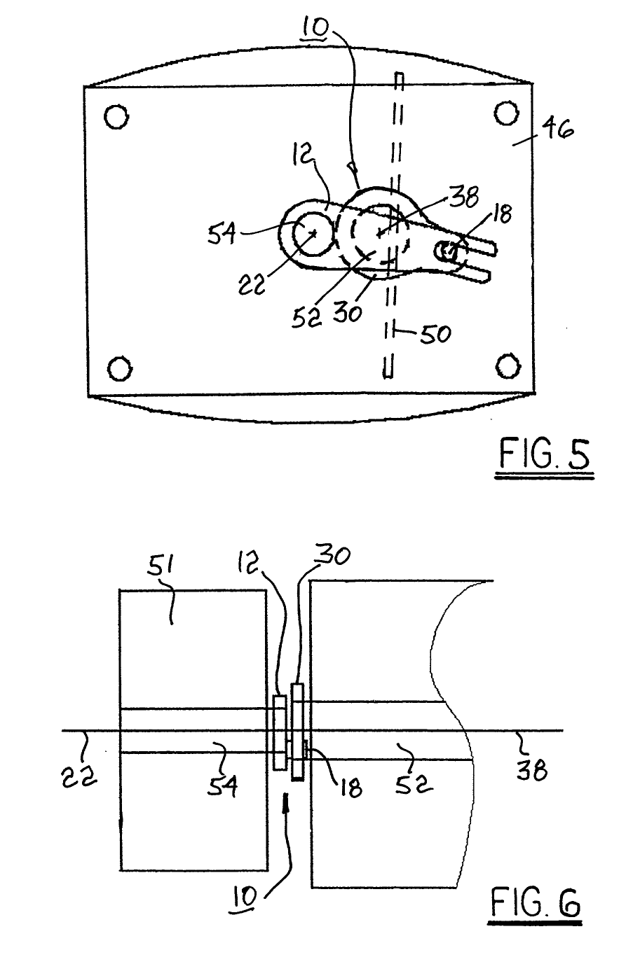

Referring to FIGS. 3 and 4, rotation amplifier 10 is shown in rotational orientation A and A′ wherein butterfly 50 is in the closed position within throttle body 46. Referring to FIGS. 5 and 6, when motor 51 is energized, actuating output shaft 54, amplifier 10 is rotated to a rotational position B and B′, pin 18 sliding along slot 34, wherein butterfly 50 is in the wide open position with respect to throttle body 46.

Motor 51 may be controlled conventionally, preferably through a feedback control loop in an engine control module (not shown) to control the position of butterfly 50. Typically, the control loop derives an input signal from a throttle position sensor 56 disposed on the end 52′ of throttle shaft 52 opposite from rotation amplifier 10, as shown in FIG. 2.

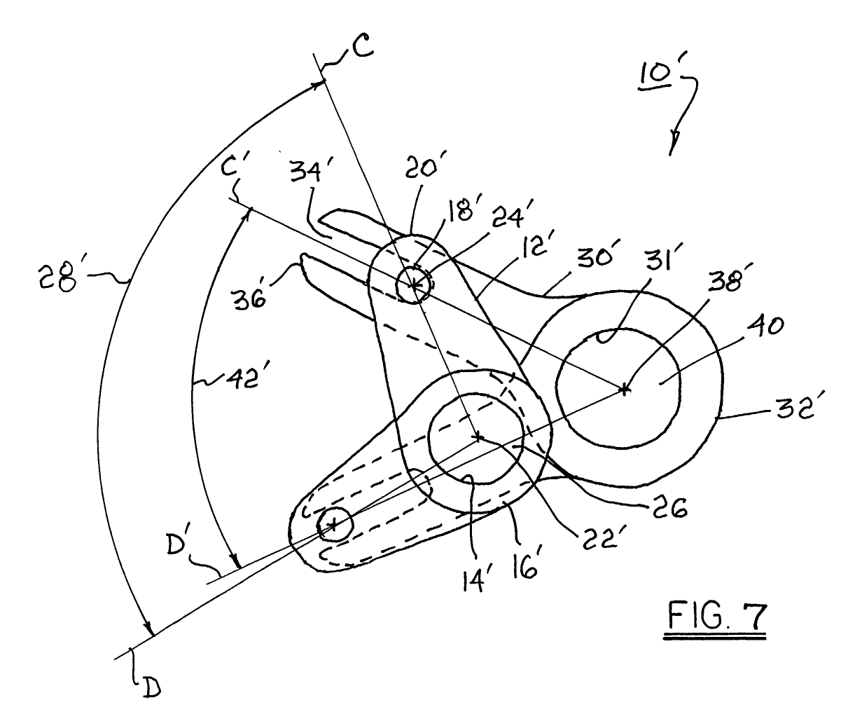

Referring to FIG. 7, a rotation reducer 10′ is shown. Rotation reducer 10′ includes a driving arm 12′ having a bore 14′ formed near a proximal end 16′ thereof and a pin 18′ rigidly disposed near a distal end 20′ thereof. Bore 14′ has an axis 22′ generally orthogonal to a plane containing arm 12′, and pin 18′ has an axis 24′ generally parallel to axis 22′. Driving arm 12′ is adapted for rigid mounting via bore 14′ in known fashion on a rotatable driving shaft 26 for actuation of arm 12′ from a first angular orientation C through angle 28′ to a second angular orientation D, which may be about 105° as shown in FIG. 7. The axis of shaft 26 is coincident with axis 22′ of bore 14′.

Rotation reducer 10′ further includes a driven arm 30′ having a bore 31′ formed near a proximal end 32′ thereof and a slot 34′, preferably radial from bore 31′, formed in a distal end 36′ thereof. Bore 31′ has an axis 38′ generally orthogonal to a plane containing arm 30′. Driven arm 30′ is adapted for rigid mounting via bore 31′ in known fashion on a rotatable driven shaft 40 for actuation by arm 30′ from a first angular orientation C′ through angle 42′ to a second angular orientation D′, which may be about 50° as shown in FIG. 7. The axis of shaft 40 is coincident with axis 38′ of bore 31′ and is substantially parallel to, and non-coaxial with, axes 22′ and 24′.

In operation, rotation of driving shaft 26 and driving arm 12′ from a first angular orientation C through an angle 28′ to a second angular orientation D causes driven arm 30′ and driven shaft 40 to be rotated from a first angular orientation C′ through an angle 42′ to a second angular orientation D′. Because axis 22′ lies between axis 38′ and axis 24′ (that is, the distance between axes 38′ and 24′ is always greater than the distance between axes 22′ and 24′), angle 42′ is less than angle 28′, and the rotary motion of driven shaft 40 is reduced from the rotary motion of driving shaft 26.

Rotation reducer 10′ is useful in applications wherein a driving apparatus has a wide angular range of motion but a low torque, such as a DC two-pole torque motor. Because the driving arm is shorter than the driven arm, the torque output is amplified.

It will be apparent that “amplifier” 10 and “reducer” 10′ may be employed as reducer and amplifier, respectively, simply by changing the definitions of shafts 26 and 40. In FIG. 1, if shaft 40 is the driving shaft and shaft 26 is the driven shaft, then embodiment 10 becomes a rotation reducer; and similarly, in FIG. 7, if shaft 26 is the driving shaft and shaft 40 is the driven shaft, then embodiment 10′ becomes a rotation amplifier. Further, it is apparent then that either one of the driving and driven arms may be provided with a slot, and the other arm be provided with a pin, to equal effect.

While the invention has been described with reference to preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention. Therefore, it is intended that the invention not be limited to the particular embodiments disclosed as the best mode contemplated for carrying out this invention, but that the invention include all embodiments falling within the scope and spirit of the appended claims.

What is claimed is:

1. A non-coaxial rotary linkage between first and second parallel shafts having first and second parallel axes, respectively, comprising;
a) a first lever arm having a slot formed in its distal end and a first bore formed in its proximal end for fixedly receiving one of said first and second shafts, said first bore having a first bore axis; and
b) a second lever arm having a pin protruding from its distal end in a direction parallel to said first and second parallel shafts and toward said first lever arm, said pin having a pin axis, said second lever arm having a second bore formed in its proximal end for fixedly receiving the other of said first and second parallel shafts, said second bore having a second bore axis, said shafts being offset such that said pin is receivable in said slot,
wherein rotation of one of said shafts through a first angle causes the other of said shafts to be rotated through a second angle different from said first angle.

2. A linkage in accordance with claim 1 wherein the distance between said first bore axis and said pin axis is greater than the distance between said second bore axis and said pin axis.

3. A linkage in accordance with claim 2 wherein said first shaft is a driving shaft and said second shaft is a driven shaft.

4. A linkage in accordance with claim 2 wherein said first shaft is a driven shaft and said second shaft is a driving shaft.

5. A linkage in accordance with claim 1 wherein the distance between said first bore axis and said pin axis is less than the distance between said second bore axis and said pin axis.

6. A linkage in accordance with claim 5 wherein said first shaft is a driving shaft and said second shaft is a driven shaft.

7. A linkage in accordance with claim 2 wherein said first shaft is a driven shaft and said second shaft is a driving shaft.

8. A throttle valve assembly for electromechanical actuation of a throttle valve comprising:
a) a throttle body having a throat therethrough;
b) a butterfly valve disposed in said throat and supported by a throttle shaft disposed in said body and extending therefrom and rotatable about a throttle shaft axis through a first angle to actuate said valve;
c) an electric motor mounted on said throttle body and having an output shaft extending toward said throttle body, said output shaft having a motor shaft axis parallel to and non-coaxial with said throttle shaft axis;
d) a first lever arm having a slot formed in its distal end and a first bore formed in its proximal end for fixedly receiving one of said throttle and motor shafts; and
e) a second lever arm having a pin protruding from its distal end in a direction parallel to said throttle and motor shafts and toward said first lever arm, said pin having a pin axis, said second lever arm having a second bore formed in its proximal end for fixedly receiving the other of said throttle and motor shafts, said pin being receivable in said slot,
wherein rotation of said motor shaft through a second angle causes said throttle shaft to be rotated through a first angle different from said second angle.

9. A throttle assembly in accordance with claim 8 wherein said electric motor is a DC torque motor.

10. A throttle assembly in accordance with claim 9 wherein said torque motor is selected from the group consisting of two-pole and four-pole.

11. A throttle assembly in accordance with claim 8 wherein the distance from said motor shaft axis to said pin axis is greater than the distance from said throttle shaft axis to said pin axis, such that said first angle is greater than said second angle.

12. A throttle assembly in accordance with claim 8 wherein the distance from said motor shaft axis to said pin axis is less than the distance from said throttle shaft axis to said pin axis, such that said first angle is less than said second angle.

13. A throttle valve assembly for electromechanical actuation of a throttle valve, comprising:
a) a throttle body having a throat therethrough;
b) a butterfly valve disposed in said throat and supported by a throttle shaft disposed in said body and extending therefrom and rotatable about a throttle shaft axis through a first angle;
c) an electric motor mounted on said throttle body and having an output shaft extending toward said throttle body, said output shaft having a motor shaft axis parallel to and non-coaxial with said throttle shaft axis; and
d) a rotation amplifier linkage connecting said throttle shaft and said motor shaft,
wherein rotation of said motor shaft through a second angle causes said throttle shaft to rotate through said first angle, and wherein said first angle is greater than said second angle.
